(19) United States
(12) Patent Application Publication
(10) Pub. No.: US 2008/0201000 A1
(43) Pub. Date: Aug. 21, 2008

(54) Contextual grouping of media items

(75) Inventors: Paivi Heikkila, Tampere (FI); Vesa Huotari, Tampere (FI); Sanna Lindroos, Tampere (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/709,101

(22) Filed: Feb. 20, 2007

(51) Int. Cl. G06F 17/00

(52) U.S. Cl. 700/94

(57) ABSTRACT

An apparatus including: a memory for recording a first context output, which is contemporaneous with when a media item was operated on, and a second context output, which is also contemporaneous with when the media item was operated upon but different to the first context output; and processing circuitry operable to associate the media item with a combination of at least the recorded first context and the recorded second context and operable to create at least a set of media items using the associated combinations of first and second contexts.

### FIELD OF THE INVENTION

Embodiments of the present invention relate to methods, apparatuses and computer program products for contextual grouping of media items.

### BACKGROUND TO THE INVENTION

It is now common for a person to use one or more devices to access media content such as music tracks and/or photographs. The content may be stored in the device as media items such as MP3 files, JPEG files, etc

Cameras, mobile telephones, personal computers, personal music players and even gaming consoles may store many different media items and it may be difficult for a user to access a preferred content item.

### BRIEF DESCRIPTION OF THE INVENTION

According to one embodiment of the invention there is provided an apparatus comprising: a memory for recording a first context output, which is contemporaneous with when a media item was operated on, and a second context output, which is also contemporaneous with when the media item was operated upon but different to the first context output; and processing circuitry operable to associate the media item with a combination of at least the recorded first context and the recorded second context and operable to create at least a set of media items using the associated combinations of first and second contexts.

This provides the advantage that the apparatus is able to categorize media items based on, for example, their historic use and the context in which they were used. The apparatus is then able to match a current context with one of several possible contexts and use this match to make intelligent suggestions of media items for use.

The media items suggested for use may be those that have historically been used in similar contexts.

Thus an in-car music player may make different suggestions for one's drive to work, one's drive from work and driving during one's leisure time.

Thus a personal music player may make different suggestions when a user is exercising, relaxing etc.

According to another embodiment of the invention there is provided a computer program product comprising computer program instructions for: recording a first context output, which is contemporaneous with when a media item was operated on, recording a second context output, which is also contemporaneous with when the media item was operated upon but different to the first context output; associating the media item with a combination of at least the recorded first context and the recorded second context; and creating at least a set of media items using the associated combinations of first and second contexts.

According to another embodiment of the invention there is provided a method comprising: recording a first context output, which is contemporaneous with when a media item was operated on, recording a second context output, which is also contemporaneous with when the media item was operated upon but different to the first context output; associating the media item with a combination of at least the recorded first context and the recorded second context; and creating at least a set of media items using the associated combinations of first and second contexts.

### BRIEF DESCRIPTION OF THE DRAWINGS

For a better understanding of the present invention reference will now be made by way of example only to the accompanying drawings in which:

FIG. 1 schematically illustrates an apparatus for contextual grouping and use of media items;

FIG. 2 schematically illustrates media items associated with context output(s);

FIG. 3, schematically illustrates contextual grouping in an illustrative multi-dimensional vector space;

FIG. 4A illustrates one method for logging context outputs;

FIG. 4B illustrates one method for grouping media items based on context of use;

FIG. 4C illustrates one method for selecting for use a grouping of media items based on context at use; and

FIG. 5 schematically illustrates a set of media items stored in the database in association with a definition of a context space.

### DETAILED DESCRIPTION OF EMBODIMENTS OF THE INVENTION

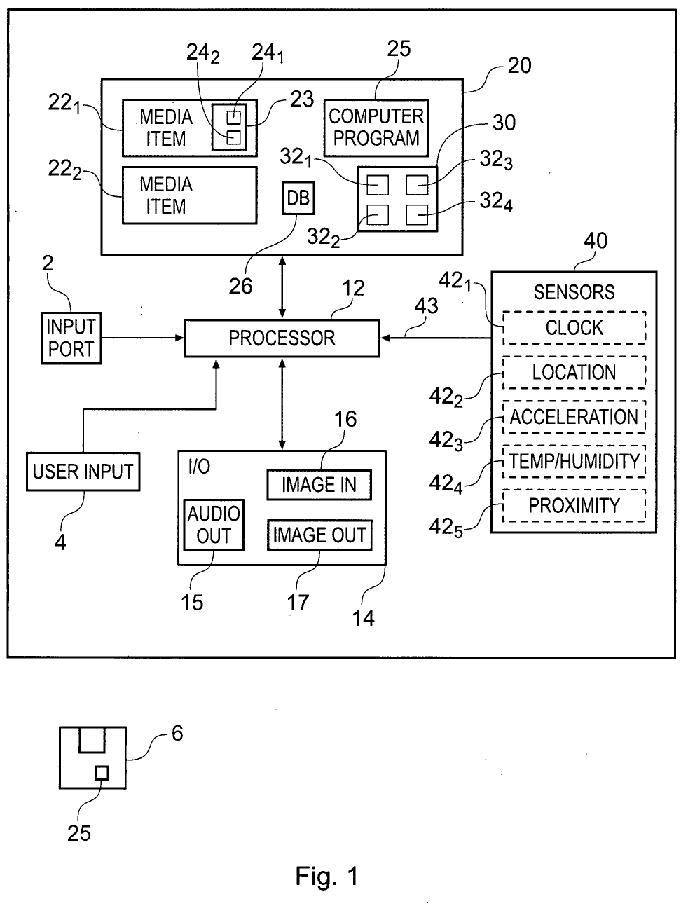

FIG. 1 schematically illustrates an apparatus 10. The apparatus 10 may in some embodiments be used as a list generator such as a music playlist generator that intelligently selects particular media items for use in dependence upon a current context of the apparatus 10. The apparatus 10 may be any suitable device such as, for example, a personal computer, a personal digital assistant, a mobile cellular telephone, a digital camera, a personal music player or another device that is capable of capturing, editing or rendering media content such as music, images, video etc. The apparatus 10 may, in some embodiments, be a hand-portable electronic device.

The illustrated apparatus 10 comprises: a memory 20; a context generator 40; an input/output device 14; a user input device 4 and an input port 2.

The memory 20 stores a plurality of media items 22 including a first media item 22₁ and a second media item 22₂, a database 26, a computer program 25 and a collection 30 of context outputs 32 from the context generator 40 including, at least, a first context output 32, and a second context output 32₂.

A media item 22 is a data structure which records media content such as visual and/or audio content. A media item 22 may, for example, be a music track, a video, an image or similar. Media items may be created using the apparatus 10 or transferred into the apparatus 10.

In the illustrated example, the first media item 22₁ is for a music track and includes music metadata 23 including, for example, genre metadata 24₁ identifying the music genre of the music track such as ‘rock’, ‘classical’ etc and including tempo metadata 24₂ identifying the tempo or beat of the music track. The music metadata 23 may include other metadata types such as, for example, metadata indicating the ‘energy’ of the music.

The music metadata 23 may be integrated as a part of the first media item 22₁ when the metadata item is transferred into the apparatus 10 or added after processing the first media item 22₁ to identify the ‘genre’, ‘tempo’ or ‘energy’.

The context outputs 32 stored in the memory 20 may, for example, be generated by the context generator 40 or received at the apparatus 10 via the input port 2.

The context generator 40 generates at least one data value (a context output) that identifies a ‘context’ or environment at a particular time. In the example illustrated, the context generator is capable of producing multiple different context outputs. It should, however, be appreciated that the context generator may not be present in all embodiments, context outputs being received via the input port 2 instead. It should, also be appreciated that the context outputs illustrated are merely illustrative and different numbers and types of context outputs may be produced.

The context generator 40 may, for example, include a real-time clock device 42₁ for generating as a context output the time and/or the day.

The context generator 40 may, for example, include a location device 42₂ for generating as a context output a location or position of the apparatus 10. The location device 42₂ may, for example, include satellite positioning circuitry that positions the apparatus 10 by receiving transmissions from multiple satellites. The location device 42₂ may, for example, be cellular mobile telephone positioning circuitry that positions the apparatus 10 by identifying a current radio cell.

The context generator 40 may, for example, include an accelerometer device 42₃ for generating as a context output the current acceleration of the apparatus. The accelerometer device 42₃ may be a gyroscope device or a solid state accelerometer.

The context generator 40 may, for example, include a weather device 42₄ for generating as a context output an indication of the current weather such as the temperature and/or the humidity.

The context generator 40 may, for example, include a proximity device 42₅ for generating as a context output an indication of which other apparatuses are nearby. The proximity device e.g. a Bluetooth transceiver may for example, use low power radio frequency transmissions to discover and identify other proximity devices nearby, for example, within a few metres or a few tens of metres.

It should be appreciated that by providing suitable sensors 40 different activities of a person carrying the apparatus 10 may be discriminated. For example, a context parameter output by the real-time clock device 42₁ may be used to determine whether, when the apparatus is used, it is being used during work-time or leisure time. For example, a context parameter output by the location device 42₂ may be used to determine whether, when the apparatus is used, it is being used while the user is stationary or moving or while the user is in particular locations. For example, a context parameter output by the accelerometer device 42₃ may be used to determine whether, when the apparatus is used, it is being used while the user is exercising. As an example, jogging may produce a characteristic acceleration and deceleration signature in the output parameter. For example, a context parameter output by the weather device 42₄ may be used to determine whether, when the apparatus is used, it is being used inside or outside etc. For example, a context parameter output by the proximity device 42₅ may be used to determine whether, when the apparatus is used, it is being used while the user of the apparatus is in the company of identifiable individuals or near a particular location.

The collection of output contexts produced or received at a moment in time define a vector that defines the current context in a multi-dimensional context space 60 (schematically illustrated in FIG. 3).

The input/output device 14 is used to operate on a media item. It may, for example, include an audio output device 15 such as a loudspeaker or ear phone jack for playing a music track. The input/output device 14 may, for example, include a camera 16 for capturing an image or video. The input/output device 14 may, for example, include a display 17 for displaying an image or video.

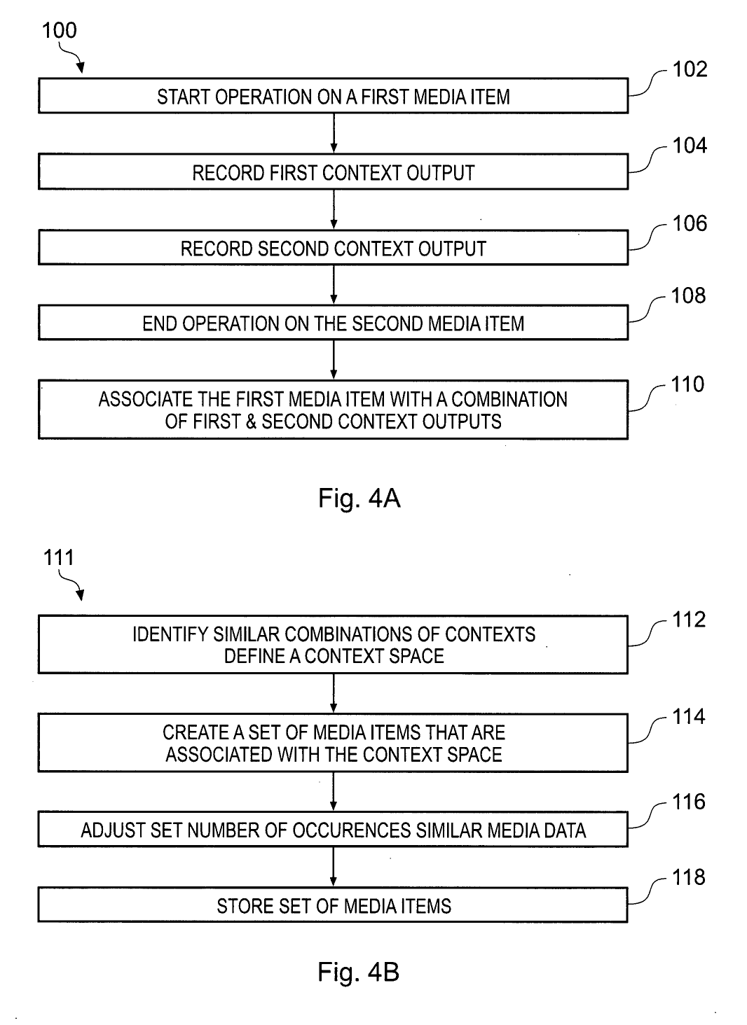

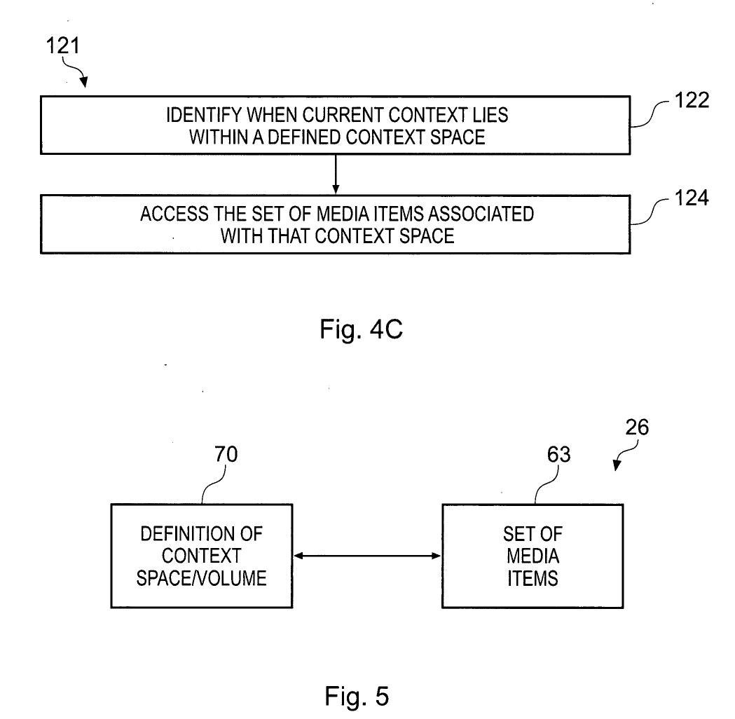

The memory 20 stores computer program instructions 25 that control the operation of the apparatus 10 when loaded into the processor 12. The computer program instructions 25 provide the logic and routines that enables the apparatus 10 to perform the methods illustrated in FIGS. 4A, 4B and 4C.

The computer program instructions may arrive at the apparatus 10 via an electromagnetic carrier signal or be copied from a physical entity 6 such as a computer program product, a memory device or a record medium such as a CD-ROM or DVD.

The operation of the apparatus 10 will not be described with reference to FIGS. 4A, 4B and 4C. These figures illustrate three separate processes or methods, each of which comprises an ordered sequence of blocks. A block represents a step in the method, or if the method is performed using computer code a code portion.

Referring to FIG. 4A, one method 100 for logging context outputs is illustrated. At block 102, the processor 12 provides a first media item 22₁ to the input/output device 14. In this particular example, the first media item 22₁ is a music track and it is provided to the audio output device 15 where it is operated upon to produce a musical output to the user.

After providing the first media item 22₁ to the input/output device 14, the processor 12 at block 104 receives a first context output 32₁ from the context generator 40 (or input port 2) and stores it in the memory 20. The first context output 32₁ is a first parameter of the current context of the apparatus 10 i.e. the context that is contemporaneous with playing the first media item 22₁.

After providing the first media item 22₁ to the input/output device 14, the processor 12 at block 106 receives a second context output 32₂ from the context generator 40 (or input port 2) and stores it in the memory 20. The second context output 32₁ is a second parameter of the current context of the apparatus 10 i.e. the context that is contemporaneous with playing the first media item 22₁. The second parameter is different from the first parameter.

The processor 12 may also receive and store additional context parameters of the current context of the apparatus 10 i.e. the context that is contemporaneous with playing the first media item 22₁. The types of context outputs recorded as context parameters may be dependent upon the type of media item being operated on.

At block 110, the processor 12 associates the first media item 22₁ with a combination of context parameters for the current context of the apparatus 10 i.e. the context that is contemporaneous with playing the first media item 22₁. The collection of output contexts produced or received at a moment in time define a vector composed of context parameters that defines the current context in a multi-dimensional context space 60

At block 108, the operation of the input/output device 14 on the first media item 22₁ is terminated.

The method 100 is repeated when the same or different media items are used by the input/output device 14.

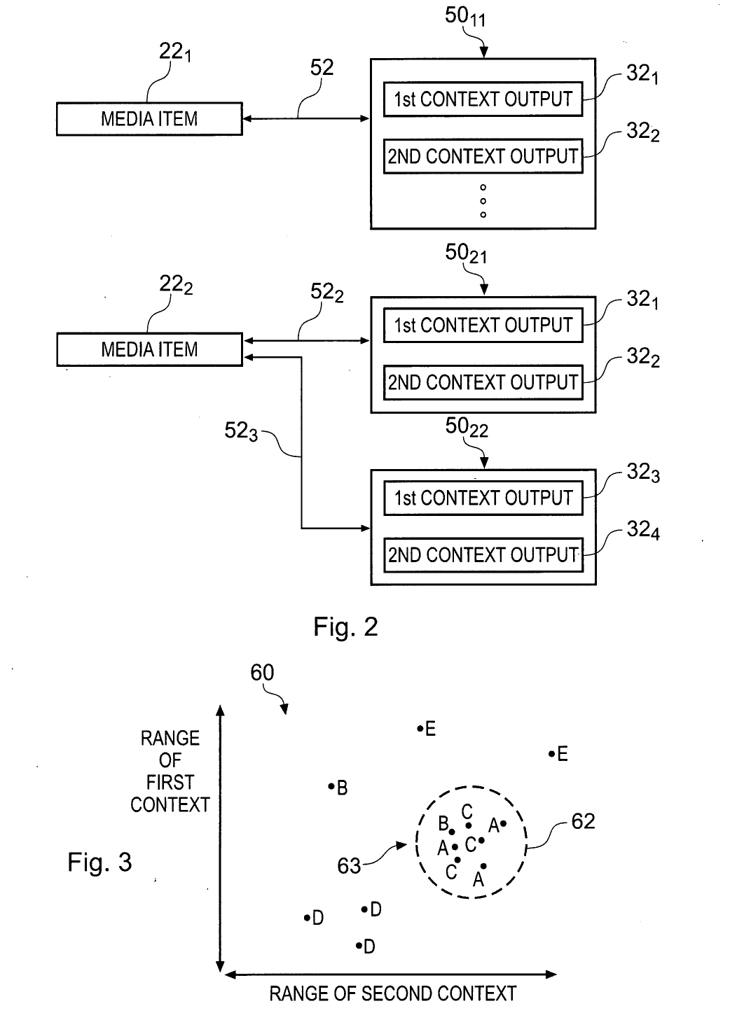

FIG. 2 schematically illustrates the associations 52 between different media items 22 and different context outputs at different times.

In the figure, the first media item 22₁ is associated 52₁ with a combination 50₁₁ of context parameters 32₁, 32₂ that were current when the first media item 22₁ was being used. A different combination 50₁₁ will be created each time the first media item 22₁ is used and will be associated with the first media item 22₁. The associations between the first media item 22₁ and the combination or combinations of context parameters 32 are stored in the database 26. A combination of context parameters 32 defines a vector in a multi-dimensional context space 60.

In the figure, the second media item 22₂ is associated 52₂ with a combination 50₂₁ of context parameters 32₁, 32₂ that were current at a time T1 when the second media item 22₂ was being used. The second media item 22₂ is also associated 52₃ with a combination 50₂₂ of context parameters 32₃, 32₄ that were current at a time T2 when the second media item 22₂ was being used. The associations between the second media item 22₂ and the combinations 50 of context parameters are stored in the database 26. A combination of context parameters 32 defines a vector in a multi-dimensional context space 60.

FIG. 3, schematically illustrates an illustrative multi-dimensional vector space 60. In this example, the space is defined by the range of the first context parameter (y-axis) and the range of the second context parameter (x-axis). Each combination 50 of first and second parameters defines a co-ordinate in the space 60 that represents a context. In the figure, the combinations associated with the media items A, B, C, D, E are illustrated. It can be seen that there is a set 63 of media items that congregate within the volume 62 of similar context parameter combinations. The volume 62 represents a ‘context’ that has historically been accompanied by use of the media items A, B and C.

As an example, for music track media items, the first context parameter may be the time and/or day (of playing the music track) and the second context parameter may be a location (of playing the music track).

As another example, for image media items, the first context parameter may be the time and/or day (of capturing/viewing the image) and the second context parameter may be a location (of capturing/viewing the image).

Referring to FIG. 4B, one method 111 for grouping media items based on context of use is illustrated. At block 112, the processor 12 identifies a group of similar combinations of contexts parameters that are associated with media items. This group is used to define a context space 62 that is likely to be populated with media items and perhaps with particular media items. The definition of the context space 62 is stored in the database 26.

At block 114, a set 63 of media items 22 is created by searching the database 62 to identify media items 22 that have associated contexts that are within the defined context space 62.

At block 116, the set 63 of media items 22 may be adjusted by the processor 12 using, for example, a threshold criterion or criteria. For example, the set may be reduced by the processor 12 to include only those media items 22 that have multiple (i.e. greater than N) associated contexts that are within the defined context space 62. For example, the processor 12 may reduce the set 63 by including only those media items 22 that have similar metadata 23. For example, in the case of music tracks the set 63 may be restricted to music tracks of similar genre and/or tempo and/or energy as identified by the processor 12. The processor 12 may, in some embodiments, augment the set 63 by including media items that have similar metadata but do not have associated contexts that are within the defined context space.

At block 118, following optional block 116, a definition of the set 63 of media items 22 is stored in the database 26 in association with the definition 70 of the context space 62 as illustrated in FIG. 5. The association may be provided with a reference that may be user editable to describe the context space e.g. ‘music to go to work by’, ‘jogging music’ etc

Referring to FIG. 4C, one method 121 for selecting a grouping of media items based on context at use is illustrated. At block 122, the processor 12 identifies when a current context lies within a defined context volume 62. The current context is defined by the context outputs 32 contemporaneously received via the input port 2 or produced by the context generator 40. This collection of contemporaneous context parameters defines a point in the context space 60 and the processor 12 determines whether it lies within one of the defined context volumes 62.

If the current context does lie within a defined context volume 62, then at block 124, the processor 12 accesses the set 63 of media items 22 associated with that context volume 62.

The processor 12 may present the set 63 of media items as a contextual play list. The play list may be presented as suggestions for user selection of individual media items for use. The playlist may be presented as a playlist for automatic use of the set of media items without further user intervention e.g. as a music compilation or image slide show.

The play lists may then be stored and referenced.

Although embodiments of the present invention have been described in the preceding paragraphs with reference to various examples, it should be appreciated that modifications to the examples given can be made without departing from the scope of the invention as claimed. For example, although association of a media item with a vector of context parameters may be achieved automatically using a processor 12 as illustrated in FIG. 4A, this may also be achieved by enabling a user to specify the context parameters associated with a media item i.e. specify the context when that media item is automatically suggested. For example, although association of a set of media items with a context volume may be achieved automatically using a processor 12 as illustrated in FIG. 4A, this may also be achieved by enabling a user to specify and label a context space i.e. specify a context for which media item are automatically suggested. For example, the methods of FIGS. 4A may 4B may be combined so that a context space is defined, then used to identify a current context lying within that context space, then create, adjust and access a set of media items.

Examples of how embodiments of the invention may be used include:
recognizing when a user is jogging and providing jogging music when this is occurring;
recognizing when a friend's phone is nearby and providing certain music;
listing music tracks that have been played previously been 9 am and 11 am if the current time is 10 am.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a memory for recording a first context output, which is contemporaneous with when a media item was operated on, and a second context output, which is also contemporaneous with when the media item was operated upon but different to the first context output; and
processing circuitry operable to associate the media item with a combination of at least the recorded first context and the recorded second context and operable to create at least a set of media items using the associated combinations of first and second contexts.

2. An apparatus as claimed in claim 1, wherein the first context output relates to one of: timing; place; acceleration; proximity and weather.

3. An apparatus as claimed in claim 1, wherein the first context output relates to one of: time and day.

4. An apparatus as claimed in claim 1, wherein the second context output relates to one of: timing; place; acceleration; proximity and weather.

5. An apparatus as claimed in claim 1, wherein the combination of the recorded first context output and the recorded second context output, defines a context for the associated media item at the point of being operated upon.

6. An apparatus as claimed in claim 1, wherein operating on the media item includes using the media item.

7. An apparatus as claimed in claim 1, wherein the media item is a music track.

8. An apparatus as claimed in claim 1, wherein the media item is music track and operation on the music track is playing the music track and wherein the first context output is the time and/or day the music track was played and the second context output is a location at which the music track was played.

9. An apparatus as claimed in claim 1, wherein operating on the media item includes generating the media item.

10. An apparatus as claimed in claim 1, wherein the media item is an image or images.

11. An apparatus as claimed in claim 1, wherein the media item is media item is an image or images and operation on the media item includes capturing the image or images and wherein the first context output is the time and/or day the image or images were captured and the second context output is the location at which the image or images were captured.

12. An apparatus as claimed in claim 1 further comprising a first device arranged to output first contexts and a second device arranged to output second contexts different to the first contexts.

12. An apparatus as claimed in claim 1, wherein the set of media items are associated with a group of similar context combinations.

13. An apparatus as claimed in claim 12, wherein the processing circuitry is operable to identify similar context combinations.

14. An apparatus as claimed in claim 1, wherein the set of media items are repeatedly associated with a group of similar context combinations.

15. An apparatus as claimed in claim 1, wherein the set of media items are associated with a group of similar context combinations and have similar first metadata.

16. An apparatus as claimed in claim 15, wherein the first metadata is music genre.

17. An apparatus as claimed in claim 15, wherein the first metadata is music tempo.

18. An apparatus as claimed in claim 15, wherein the processing circuitry is operable to identify media items having similar first metadata.

19. An apparatus as claimed in claim 1, wherein the processing circuitry operates automatically, without user intervention, to associate the media item with the combination.

20. An apparatus as claimed in claim 1, wherein the processing circuitry is operable in response to user input to associate a media item with a combination, processing circuitry operable to associate the media item with a combination of user defined contexts including first and second contexts.

21. An apparatus as claimed in claim 1, wherein the processing circuitry is operable to use of the set of media items.

22. A playlist generator embodied in the apparatus of claim 1.

23. A music player embodied in the apparatus of claim 1.

24. A computer program product comprising computer program instructions for:
recording a first context output, which is contemporaneous with when a media item was operated on,
recording a second context output, which is also contemporaneous with when the media item was operated upon but different to the first context output;
associating the media item with a combination of at least the recorded first context and the recorded second context;
creating at least a set of media items using the associated combinations of first and second contexts.

25. A computer program product as claimed in claim 24, wherein the program instructions are for:
identifying a group of similar context combinations; and
creating the set of media items using the media items that are associated with the group of similar context combinations.

26. A computer program product as claimed in claim 24, wherein the program instructions are for:
identifying a group of similar context combinations; and
creating the set of media items using the media items that are repeatedly associated with the group of similar context combinations.

27. A computer program product as claimed in claim 24, wherein the program instructions are for:
identifying a group of similar context combinations;
identifying a first set of media items that are associated with the group of similar context combinations; and
identifying a second set of media items that are within the first set and have similar first metadata.

28. A computer program product as claimed in claim 24, wherein the program instructions are for: presenting the set of media items as a suggested play list.

29. A computer program product as claimed in claim 24, wherein the program instructions are for: automatically playing the set of media items as a play list.

30. A record medium embodying the computer program product as claimed in claim 24.

31. A method comprising:
recording a first context output, which is contemporaneous with when a media item was operated on,
recording a second context output, which is also contemporaneous with when the media item was operated upon but different to the first context output;
associating the media item with a combination of at least the recorded first context and the recorded second context; and
creating at least a set of media items using the associated combinations of first and second contexts.

32. A method as claimed in claim 31 comprising:
identifying a group of similar context combinations; and
creating the set of media items using the media items that are associated with the group of similar context combinations.

33. A method as claimed in claim 31 comprising:
identifying a group of similar context combinations; and
creating the set of media items using the media items that are repeatedly associated with the group of similar context combinations.

34. A method as claimed in claim 31 comprising:
identifying a group of similar context combinations;
identifying a first set of media items that are associated with the group of similar context combinations; and
identifying a second set of media items that are within the first set and have similar first metadata.

35. A method as claimed in claim 31 comprising:
presenting the set of media items as a suggested play list.

36. A method as claimed in claim 31 comprising:
automatically playing the set of media items as a play list.

37. An apparatus comprising:
storage means for recording a first context output, which is contemporaneous with when a media item was operated on, and a second context output, which is also contemporaneous with when the media item was operated upon but different to the first context output; and
processing means operable to associate the media item with a combination of at least the recorded first context and the recorded second context and operable to create at least a set of media items using the associated combinations of first and second contexts.
